(19) United States
(12) Patent Application Publication
(10) Pub. No.: US 2012/0024646 A1
(43) Pub. Date: Feb. 2, 2012

(54) DAMPING STRUCTURE

(75) Inventors: Kazuki Tsugihashi, Hyogo (JP); Akio Sugimoto, Hyogo (JP); Zenzo Yamaguchi, Hyogo (JP); Kyoko Masuda, Hyogo (JP); Yoshio Yano, Hyogo (JP)

(73) Assignee: Kabushiki Kaisha Kobe Seiko Sho (Kobe Steel, Ltd.), Hyogo (JP)

(21) Appl. No.: 13/138,861

(22) PCT Filed: Apr. 9, 2010
(86) PCT No.: PCT/JP2010/056475

§ 371 Date: Oct. 11, 2011

(30) Foreign Application Priority Data
Apr. 9, 2009 (JP) 2009-095081

(51) Int. Cl. F16F 9/30

(52) U.S. Cl. 188/268

(57) ABSTRACT

The present invention provides a damping structure capable of obtaining a sufficient damping effect even against vibrations with small amplitudes, by promoting movements of powder/particle materials in a hollow body. In the damping structure of the invention, a damping member 2 is provided on a structure 1 to be damped. The damping member 2 is composed of a hollow body 5, a powder/particle material 3 which is filled in the hollow body 5 with partially leaving a space 4, and moves inside the hollow body 5 when the structure 1 vibrates, and a vibrator 6 which is mounted inside the hollow body 5, and relatively vibrates with respect to the hollow body 5. The vibrator 6 exerts a force by coming into contact with the powder/particle material, when vibrating.

### TECHNICAL FIELD

The present invention relates to a damping structure which can be effectively used in a vibrating structure.

### BACKGROUND ART

A stator and a rotor of a motor or a generator, gears and rotation shafts of a reduction gear, beam members of a transport machine such as an automobile, a frame structure of a building, a large-sized mechanical structure, a structure for fixing the same, and so on generally vibrate. A damping technique for depressing vibration of such a structure, by providing a damping member having a hollow body in which powder/particle materials such as particle or powder are filled in a closed space, on the structure which is vibrating, has been already developed. This technique has been actually adopted, in a field where the vibration cannot be overcome by a technique using damping material such as elastic material or a vibration absorbing device, which has been heretofore widely employed. Such a technique has been proposed in Patent Documents 1 and 2, and so on.

In the technique disclosed in Patent Document 1, vibration of a motor having various kinds of frequencies and level characteristics is intended to be reduced, by fixing a damping member filled with powder/particle materials to the motor. Moreover, in the technique disclosed in Patent Document 2, cavities are formed in a timing pulley which is meshed with a timing belt for transmitting a motive power, and powder/particle materials are movably disposed in the cavities, thereby to damp vibration generated by the mesh between the timing belt and the pulley, and to reduce noises.

By adopting these techniques, it is certainly possible to obtain the damping effect. However, the damping effect by using the powder/particle materials has such a feature that it has non-linear characteristics, and therefore, there is a problem that by simply filling the cavities with the powder/particle materials, reliable damping effect cannot be obtained, depending on conditions.

Moreover, by adopting these techniques, sufficient damping effect cannot be obtained against vibrations with small amplitudes. The damping effect by using the powder/particle materials is realized by mutual collisions, deformations, and frictions of the powder/particle materials which are generated, when the powder/particle materials move with vibration. Particularly, in the case where vibration in a vertical direction is an object to be damped, the powder/particle materials must move against gravitational force. Therefore, there has been a problem that vibration acceleration of 1 G or more is required for obtaining the damping effect.

### PRIOR ART DOCUMENT

### Patent Document

Patent Document 1: JP-A-2000-46103

Patent Document 2: JP-A-6-288463

### SUMMARY OF THE INVENTION

### Problems that the Invention is to Solve

This invention has been made in order to solve the above described problems in the prior art, and it is an object of the invention to provide a damping structure capable of obtaining sufficient damping effect even against vibration with small amplitude, by promoting movements of powder/particle materials in a hollow body.

### Means for Solving the Problems

According to the invention, it is a damping structure comprising a damping member which is provided on a structure to be damped, wherein the damping member is composed of: a hollow body; a powder/particle material which is filled in the hollow body with partially leaving a space, and moves inside the hollow body when the structure vibrates; and a vibrator which is mounted to the hollow body, and relatively vibrates with respect to the hollow body to come into contact with the powder/particle material to exert a force when the structure vibrates.

In the invention, it is preferable that the vibrator vibrates with larger amplitude than the hollow body or in a different phase.

In addition, in the invention, it is preferable that the vibrator is mounted to the hollow body so that a vibration direction of the vibrator is different from a vibration direction of the structure.

In addition, in the invention, it is preferable that the vibrator is provided so that a shape or mass distribution of the vibrator is unsymmetrical with respect to an axis which passes a point where the vibrator is mounted to the hollow body and is in parallel with the vibration direction of the structure.

In addition, in the invention, it is preferable that an inner wall face of the hollow body is formed in an inclined state with respect to the vibration direction of the structure.

In addition, in the invention, it is preferable that a plurality of the vibrators are provided in the hollow body, and the plurality of the vibrators are constructed so as to vibrate with different amplitudes, respectively, when the structure vibrates.

In addition, in the invention, it is preferable that the vibrator is provided by passing loosely through the hollow body so that at least one end of the vibrator is protruded from the hollow body to an exterior.

### Advantage of the Invention

According to the invention, the vibrator, which is provided so as to come into contact with the powder/particle materials thereby to exert a force when the structure vibrates, vibrates inside the hollow body and promotes movements of the powder/particle materials in the hollow body. Therefore, the powder/particle materials more violently move, as compared with a case where only the powder/particle materials are filled in the hollow body. In this manner, vibration energy of the structure can be absorbed, by mutual collisions, elastic deformations, and frictions of the powder/particle materials, and the damping effect can be reliably realized even against small vibration having vibration acceleration of less than 1 G.

Moreover, in this invention, in the case where the vibrator vibrates with the larger amplitude than the hollow body or in a different phase, the powder/particle materials more violently move, on receiving vibration of the vibrator. In this manner, the vibration energy of the structure can be absorbed, by mutual collisions, elastic deformations, and frictions of the powder/particle materials, and the damping effect can be reliably realized even against small vibration having vibration acceleration of less than 1 G.

Moreover, in this invention, in the case where the vibrator is mounted to the hollow body so that the vibration direction of the vibrator is different from the vibration direction of the structure, the vibrator vibrates in a direction where the powder/particle materials are less influenced with the gravity, that is, in directions other than the vertical direction, even though the structure vibrates in the vertical direction. As the results, the movements of the powder/particle materials inside the hollow body can be reliably promoted, and the damping effect can be more reliably realized, even in the case where the vibration of the structure is small.

Moreover, in this invention, in the case where the vibrator is provided so that the shape or the mass distribution of the vibrator is unsymmetrical with respect to an axis which passes a point where the vibrator is mounted to the hollow body and is in parallel with the vibration direction of the structure, the vibrator vibrates more reliably and more violently in a direction different from the vibration direction of the structure, on receiving the vibration of the structure. Because it is provided so as to have an unbalanced structure with respect to the axis in the vibration direction of the structure, as described above, the damping effect can be more reliably realized even in the case where the vibration of the structure to be damped is small.

Moreover, in this invention, in the case where the inner wall face of the hollow body is formed in an inclined state with respect to the vibration direction of the structure, the powder/particle materials, which vibrate with convection inside the hollow body, on receiving the vibration of the vibrator, are brought into contact with the inclined inner wall face, and easily transmit the damping effect with respect to the vibration direction of the structure, to the hollow body. As the results, even in the case where the vibration of the structure to be damped is small, the damping effect can be more reliably realized.

Moreover, in this invention, in the case where a plurality of the vibrators are provided in the hollow body, and the plurality of the vibrators vibrate with different amplitudes, respectively, when the structure vibrates, the damping effect can be more reliably realized even against small vibrations in a wider range of frequencies, because the vibrators have respectively different frequency characteristics of vibration amplitudes.

Moreover, in this invention, in the case where the vibrator is provided by passing loosely thorough the hollow body so that at least one end of the vibrator is protruded from the hollow body to the exterior, the end of the vibrator which is protruded to a space outside the hollow body reliably vibrates, even though the vibrator is embedded in the powder/particle materials inside the hollow body and is unlikely to vibrate under the weight of the powder/particle materials. As the results, the vibrator vibrates, and the damping effect can be reliably realized.

### BRIEF DESCRIPTION OF THE DRAWINGS

FIG. 1 is a vertical sectional view of an embodiment of the invention in which a vibrator in a shape of a rod or a plate is protruded from an inner wall face of a hollow body in a cantilever manner.

FIG. 2 is a vertical sectional view of an embodiment of the invention in which a vibrator in a shape of a massive body is held between upper and lower inner wall faces of a hollow body by means of springs.

FIG. 3 is a vertical sectional view of an embodiment of the invention in which a vibrator in a shape of a rod or a plate is provided on a bottom face of a hollow body.

FIG. 4 is a vertical sectional view of an embodiment of the invention in which a vibrator in a shape of a rod or a plate is suspended from an upper face of a hollow body.

FIG. 5 is a vertical sectional view of an embodiment of the invention in which a vibrator in a shape of a rod or a plate is provided on a bottom face of a hollow body in an inclined state.

FIG. 6 is a vertical sectional view of an embodiment of the invention in which a vibrator in a shape of a rod or a plate which is bent at a right angle at its upper end is provided on a bottom face of a hollow body.

FIG. 7 is a vertical sectional view of an embodiment of the invention in which inner wall faces of a hollow body are inclined.

FIG. 8 is a vertical sectional view of an embodiment of the invention in which inner wall faces of a hollow body are inclined in such a manner that a direction of inclination is changed on halfway.

FIG. 9 is a vertical sectional view of an embodiment of the invention in which a plurality of vibrators in a shape of a rod or a plate having different lengths are provided.

FIG. 10 is a vertical sectional view of an embodiment of the invention in which a plurality of vibrators having different masses are held by means of springs.

FIG. 11 is a vertical sectional view of an embodiment of the invention in which a vibrator in a shape of a rod or a plate is provided so as to protrude to the exterior by passing through a hollow body.

FIG. 12 is a vertical sectional view of an embodiment of the invention in which damping members are incorporated in a stator of a motor.

FIG. 13 is a vertical sectional view of another embodiment of the invention in which damping members are incorporated in a stator of a motor.

### MODE FOR CARRYING OUT THE INVENTION

Now, the invention will be further described in detail, referring to the embodiments as shown in the attached drawings.

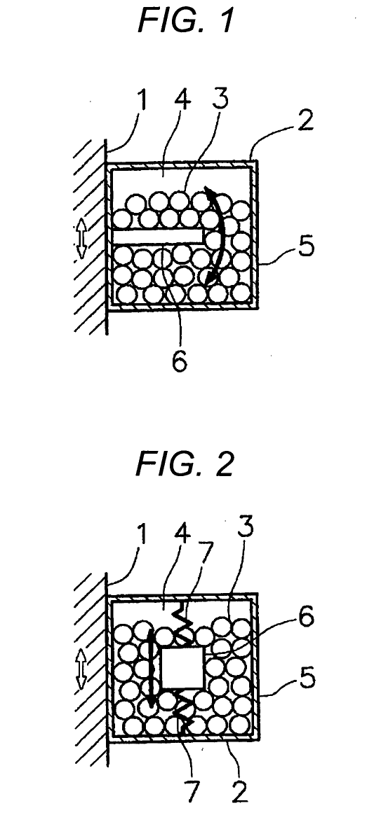

To begin with, those embodiments in which a damping member 2 is mounted on a side face of a structure 1 to be damped, which is in parallel with a vibration direction of the structure 1, will be described. A case where the damping member 2 is provided outside the structure 1 to be damped will be described, mainly referring to the embodiments in which the damping member 2 is mounted on the side face of the structure 1. However, it is of course possible to realize the damping effect, even though the damping member 2 is mounted on other places such as an upper face of the structure 1. Moreover, in the embodiments as shown in FIGS. 1 to 11, the structure 1 to be damped is, for example, a stator of a motor or a generator, a frame structure of a building or the like.

In the embodiment as shown in FIG. 1, the damping member 2 is so constructed that powder/particle materials 3 are filled in a hollow body 5 which is a container in a cubical shape, with partially leaving a space 4, and a vibrator 6 in a shape of a rod or a plate is protruded in a cantilever manner from an inner wall face of the hollow body 5. The vibrator 6 is so arranged as to be covered with the powder/particle materials 3, and can exert a force on the powder/particle materials 3 by coming into contact with them, when vibrating. The powder/particle materials 3 can move inside the hollow body 5, because the powder/particle materials 3 are filled in the hollow body 5, with partially leaving the space 4. The powder/particle materials 3 and the hollow body 5 are formed of metal such as steel and aluminum, resin such as plastic and rubber, or ceramics such as glass and sintered substance. Moreover, the powder/particle materials 3 which are described in this invention mean powder or particle, and may include not only a mixture of the powder and the particle, but also either of the powder or the particle.

In this embodiment, when vibration in the vertical direction, as shown by a bidirectional white arrow, occurs in the structure 1, the damping member 2 (hollow body 5) also vibrates in the vertical direction. The vibrator 6 which is mounted on the inner wall face of the hollow body 5 in the cantilever manner more remarkably vibrates in the vertical direction around its mounting point being a base point. The powder/particle materials 3 inside the hollow body 5 more violently vibrate, because they receive the vibration from the hollow body 5, and additionally receive the vibration from the vibrator 6.

Due to the more violent movements of the powder/particle materials 3, vibration energy of the structure 1 is converted into energy such as elastic deformations, frictions and collisions between particles (powder/particle materials 3). As the results, the vibration energy is dispersed, and hence, a damping function is generated thereby to depress the vibration of the structure 1.

It is preferable that the vibrator 6 is so constructed as to sympathetically vibrate in a frequency zone to be damped, because the vibrator 6 can move the powder/particle materials 3 more violently in this manner.

In the embodiment as shown in FIG. 2, the damping member 2 is so constructed that the powder/particle materials 3 are filled in a hollow body 5 which is a container in a cubical shape, with partially leaving a space 4, and a vibrator 6 formed of a massive body is held between upper and lower inner wall faces of the hollow body 5 by means of springs 7. The vibrator 6 is so arranged as to be covered with the powder/particle materials 3. Other structures are substantially the same as in the embodiment as shown in FIG. 1.

In this embodiment too, when vibration in the vertical direction, as shown by a bidirectional white arrow, occurs in the structure 1 to be damped, the damping member 2 (hollow body 5) also vibrates in the vertical direction, and the vibrator 6 which is held between the inner wall faces of the hollow body 5 by means of the springs 7 more remarkably vibrates in the vertical direction. The powder/particle materials 3 inside the hollow body 5 more violently vibrate, because they receive the vibration from the hollow body 5, and additionally the movement thereof is promoted by the movement of the vibrator 6.

As the results, the vibration energy of the structure 1 is converted into the energy such as elastic deformations, frictions and collisions between particles (powder/particle materials 3). Namely, the vibration energy is dispersed, and the vibration of the structure 1 is depressed by the damping function. Also in this embodiment, it is preferable that the vibrator 6 is so constructed as to sympathetically vibrate in a frequency zone to be damped, because the vibrator 6 can move the powder/particle materials 3 more violently in this manner. The springs 7 for supporting the vibrator 6 may be appropriately selected out of coil springs, leaf springs, and flat springs, which are formed of metal, and elastic resin material such as rubber, according to environment where the damping member 2 is used.

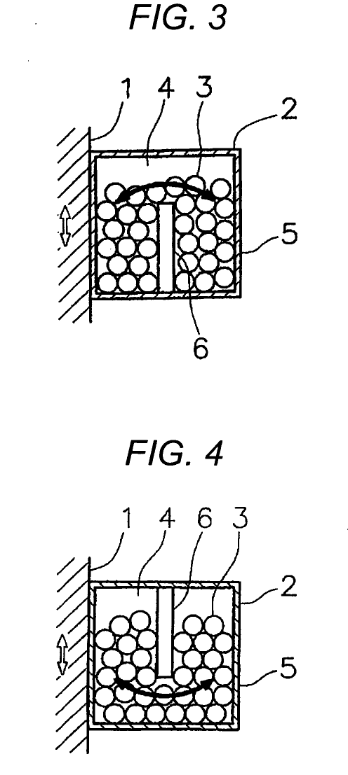

In the embodiment as shown in FIG. 3, the damping member 2 is so constructed that the powder/particle materials 3 are filled in a hollow body 5 which is a container in a cubical shape, with partially leaving a space 4, and a vibrator 6 in a shape of a rod or a plate is provided on a bottom face (inner wall face) of the hollow body 5 so as to be covered with the powder/particle materials 3.

In this embodiment, when vibration in the vertical direction, as shown by a bidirectional white arrow, occurs in the structure 1 to be damped, the damping member 2 (hollow body 5) also vibrates in the vertical direction. On the other hand, the vibrator 6 vibrates in both right and left directions around its mounting point (lower part) being a base point. The powder/particle materials 3 inside the hollow body 5 receive the vibration from the hollow body 5, and additionally receive the vibration in the lateral direction from the movements of the vibrator 6 in the lateral direction, and hence, the powder/particle materials 3 more violently vibrate in the lateral direction where they easily move without being influenced by the gravity.

Due to the more violent movements of the powder/particle materials 3, it is promoted that the vibration energy of the structure 1 is converted into energy such as elastic deformations, frictions and collisions between particles (powder/particle materials 3), and the vibration of the structure 1 is depressed by the damping function. Also, in this embodiment, it is preferable that the vibrator 6 is so constructed as to sympathetically vibrate in the frequency zone to be damped, because the vibrator 6 can move the powder/particle materials 3 more violently in this manner.

In the embodiment as shown in FIG. 3, the vibrator 6 in a shape of a rod or a plate is provided on the bottom face which is perpendicular to the vibration direction of the structure 1, and the vibrator 6 vibrates in a direction perpendicular to the vibration direction of the structure 1. However, the vibrator 6 may be mounted, for example, on the bottom face which is inclined, provided that the vibration direction of the vibrator 6 is different from the vibration direction of the structure 1.

In the embodiment as shown in FIG. 4, the powder/particle materials 3 are filled in a hollow body 5 which is a container in a cubical shape, with partially leaving a space 4, and a vibrator 6 in a shape of a rod or a plate is suspended from an upper face (inner wall face) of the hollow body 5 so as to be covered with the powder/particle materials 3.

In this embodiment, when vibration in the vertical direction, as shown by a bidirectional white arrow, occurs in the structure 1, the damping member 2 (hollow body 5) also vibrates in the vertical direction. On the other hand, the vibrator 6 vibrates in both the right and left directions around its mounting point (upper part) being a base point. Therefore, the powder/particle materials 3 inside the hollow body 5 more violently vibrate in the same manner as in the embodiment as shown in FIG. 3, and the damping effect is enhanced.

In this embodiment, an upper part of the vibrator 6 is not present in the powder/particle materials 3, but is present in the space 4 inside the hollow body 5. Therefore, pressures of the powder/particle materials 3 for obstructing the movements of the vibrator 6 in both the right and left directions are smaller than that of the case in the embodiment as shown in FIG. 3, and the vibrator 6 reliably vibrates even in the case where the structure 1 more weakly vibrates.

In this embodiment too, it is preferable that the vibrator 6 is so constructed as to sympathetically vibrate in the frequency zone to be damped, because the vibrator 6 can move the powder/particle materials 3 more violently in this manner. Moreover, the vibrator 6 may be mounted on the inclined upper face.

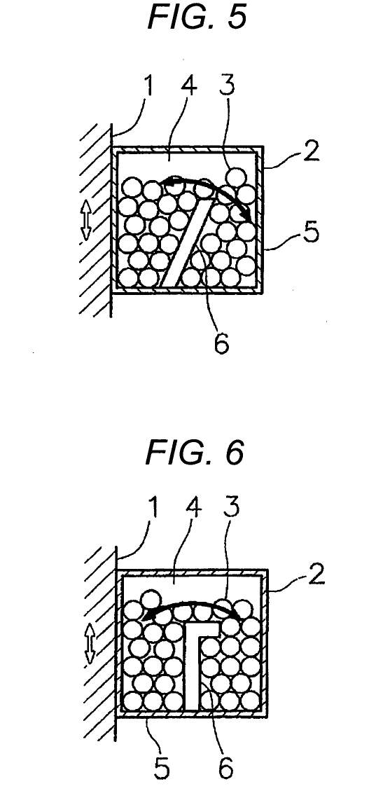

In the embodiments as shown in FIGS. 5 and 6, in the same manner as in the embodiment as shown in FIG. 3, the damping member 2 is so constructed that the powder/particle materials 3 are filled in a hollow body 5 which is a container in a cubical shape, with partially leaving a space 4, and a vibrator 6 in a shape of a rod or a plate is provided on a bottom face (inner wall face) of the hollow body 5 so as to be covered with the powder/particle materials 3. However, in these embodiments, a shape of the vibrator 6 is unsymmetrical with respect to an axis which passes a mounting part of the vibrator 6 (a base point of vibration of the vibrator 6) and is in parallel with the vibration direction of the structure 1. More comprehensively, in the embodiments as shown in FIGS. 5 and 6, the vibrator 6 is provided in an unsymmetrical manner in the lateral direction in the drawings. Specifically, in the embodiment as shown in FIG. 5, the vibrator 6 is so shaped as to be inclined with respect to the vibration direction of the structure 1, even in a state where the vibrator 6 is not vibrating. In the embodiment as shown in FIG. 6, the vibrator 6 is so shaped as to be bent at a right angle at its upper end.

In these embodiments, the vibrator 6 is provided so as to have an unsymmetrical shape in the lateral direction in the drawings. Therefore, even though the structure 1 to be damped vibrates in the vertical direction as shown by a bidirectional white arrow, vibration of the vibrator 6 in the lateral direction is likely to be excited, and hence, the vibrator 6 vibrates in the lateral direction. As the results, more remarkable damping effect can be obtained in the same manner as in the embodiment as shown in FIG. 3.

It is to be noted that not only the shape of the vibrator 6, but also distribution of mass in the vibrator 6 may be unsymmetrical.

In these embodiments too, it is preferable that the vibrator 6 is so constructed as to sympathetically vibrate in the frequency zone to be damped, because the vibrator 6 can move the powder/particle materials 3 more violently in this manner.

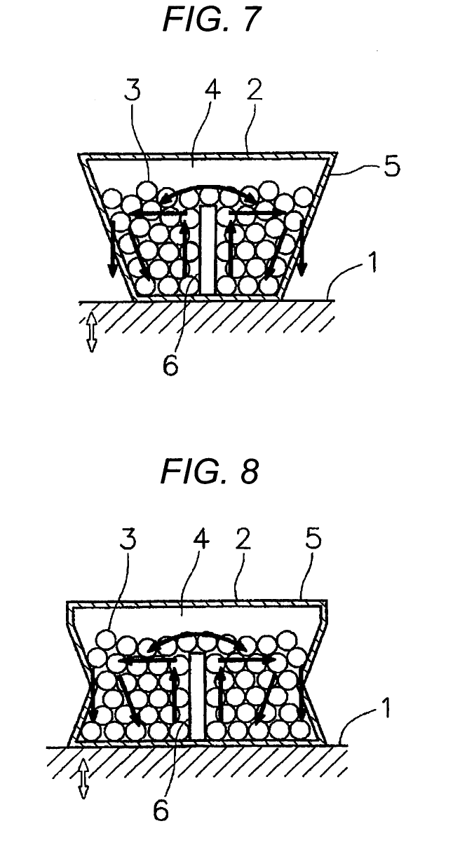

In the embodiments as shown in FIGS. 7 and 8, in the same manner as in the embodiment as shown in FIG. 3, the damping member 2 is so constructed that the powder/particle materials 3 are filled in a hollow body 5 with partially leaving a space 4, and a vibrator 6 in a shape of a rod or a plate is provided on a bottom face (inner wall face) of the hollow body 5 so as to be covered with the powder/particle materials 3. It is to be noted that in these embodiments, the vibrator 6 need not be necessarily in a shape of a rod or a plate, but may be a massive body, for example, which is held between the inner wall faces of the hollow body 5 at both sides, by means of springs.

These embodiments are different from the embodiment as shown in FIG. 3 in that the side faces (inner wall faces) of the hollow body 5 are inclined with respect to the vibration direction of the structure 1. In the embodiment as shown in FIG. 7, the inner wall faces of the hollow body 5 are inclined in one direction, and the hollow body 5 is formed in a trapezoidal shape having a shorter lower side in vertical section. Meanwhile, in the embodiment as shown in FIG. 8, the inner wall faces are inclined in such a manner that the direction of inclination is changed on halfway, and the hollow body 5 is formed in a drum shape having a neck portion on the halfway (sandglass shape), in vertical section. It is to be noted that a vertical sectional shape of the hollow body 5 may be any other shape such as a trapezoidal shape having a shorter upper side, a parallelogram, a drum shape which is swelled on the halfway, provided that the side faces (inner wall faces) of the hollow body 5 are formed in an inclined state with respect to the vibration direction of the structure 1. The side faces (inner wall faces) of the hollow body 5 may be curved faces.

In these embodiments, because the side faces of the hollow body 5 are inclined, the damping member 2 (hollow body 5) is mounted on the upper face of the structure 1. However, it is also possible to mount the damping member 2 on the side face of the structure 1, by increasing a wall thickness of the side wall of the hollow body 5, or by forming one of the side faces of the hollow body 5 to be mounted to the structure 1 as a vertical face.

In these embodiments too, when vibration in the vertical direction occurs in the structure 1, as shown by a bidirectional white arrow, the vibrator 6 swings both in the right and left directions as shown by a bidirectional black arrow. The movements of the powder/particle materials 3 in the hollow body 5 in the right and left directions are promoted by the movements of the vibrator 6, in the same manner as in the embodiments as shown in FIGS. 3 to 6.

Due to the promoted movements of the powder/particle materials 3, the vibration energy of the structure 1 is dispersed as the energy such as elastic deformations, frictions and collisions between particles (powder/particle materials 3), and hence, the vibration of the structure 1 is depressed.

Further, receiving the movements of the vibrator 6, convections of the powder/particle materials 3 are generated in the hollow body 5, as shown, for example, by unidirectional black arrows in FIGS. 7 and 8 (conventions can be also generated in the embodiments as shown in FIGS. 3 to 6). Dispersion of the vibration energy due to the elastic deformations, frictions, collisions and the like is realized between the inner wall faces of the hollow body 5 and the powder/particle materials 3 which fall down along the inner wall faces, by the convections. However, in the case where the inner wall faces are inclined, the dispersion of the energy is enhanced, because the inclined inner wall faces come into contact, at an angle, with the powder/particle materials 3 which fall down by the convections. As the results, even in the case where the vibration of the structure 1 is small, a large damping effect can be more reliably realized by the damping member 2.

In these embodiments too, it is preferable that the vibrator 6 is so constructed as to sympathetically vibrate in the frequency zone to be damped, because the vibrator 6 can move the powder/particle materials 3 more violently in this manner.

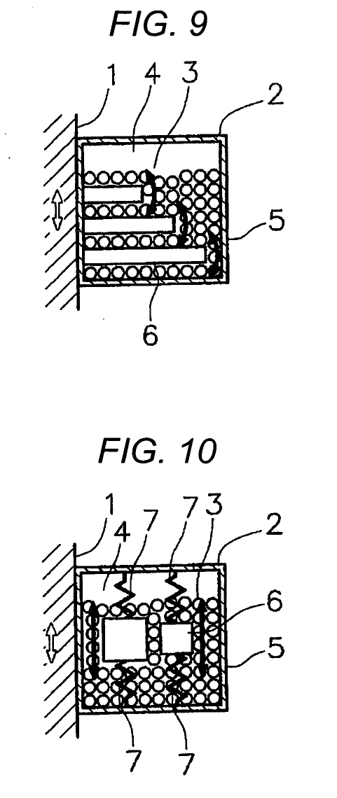

In the embodiment as shown in FIG. 9, the damping member 2 is so constructed that the powder/particle materials 3 are filled in a hollow body 5 which is a container in a cubical shape, with partially leaving a space 4, and vibrators 6 in a shape of a rod or a plate are protruded in a cantilever manner, from an inner wall face of the hollow body 5. Moreover, in the embodiment as shown in FIG. 10, it is so constructed that the powder/particle materials 3 are filled in a hollow body 5 which is a container in a cubical shape with partially leaving a space 4, and vibrators 6 formed of a massive body are held between upper and lower inner wall faces of the hollow body 5 by means of springs 7. In these embodiments, the vibrators 6 are so provided as to be covered with the powder/particle materials 3, in the same manner as in the embodiments as shown in FIGS. 1 and 2, but these embodiments are different from the embodiments as shown in FIGS. 1 and 2, in that a plurality of the vibrators 6 are provided in the hollow body 5.

In the embodiments as shown in FIGS. 9 and 10, it is so constructed that when the structure 1 vibrates, a plurality of the vibrators 6 vibrate with different amplitudes, respectively. Specifically, in the embodiment as shown in FIG. 9, the vibrators 6 have different lengths, respectively, and in the embodiment as shown in FIG. 10, the vibrators 6 have different masses, respectively. By constructing in this manner, frequency characteristics of vibration amplitudes of the vibrators 6 are different from one another. As the results, it is possible to realize more reliable damping effect even against small vibrations in a wider frequency range, as compared with the case where the only one vibrator 6 is provided, or the case where a plurality of the vibrators 6 having the same structure are provided.

In these embodiments too, it is preferable that the vibrators 6 are so constructed as to sympathetically vibrate in the frequency zone to be damped, because the vibrators 6 can move the powder/particle materials 3 more violently in this manner.

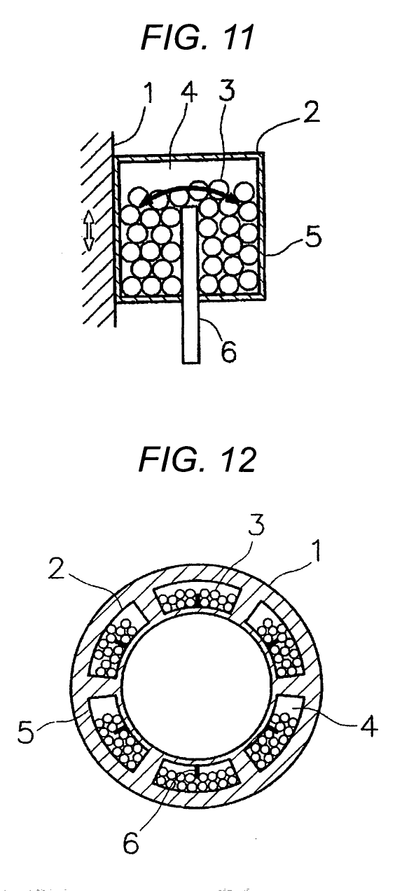

In the embodiment as shown in FIG. 11, the damping member 2 is so constructed that the powder/particle materials 3 are filled in a hollow body 5 which is a container in a cubical shape, with partially leaving a space 4, and a vibrator 6 in a shape of a rod or a plate is provided so as to pass loosely through a bottom face (inner wall face) of the hollow body 5. One end of the vibrator 6 is covered with the powder/particle materials 3 inside the hollow body 5, while the other end thereof is protruded to an exterior of the hollow body 5. By forming a through hole which is rather larger than a cross section of the vibrator 6 in the bottom face of the hollow body 5, and by forming a flange (not shown) around the vibrator 6, it is possible to provide the vibrator 6 in a state that the vibrator 6 is passing loosely through the hollow body 5. The powder/particle materials 3 can be prevented from falling through a gap between the vibrator 6 and the though hole, by making a width of the gap between the vibrator 6 and the though hole smaller than a diameter of the powder/particle materials 3, or by covering the gap between the vibrator 6 and the though hole with an elastic substance such as rubber.

In this embodiment, the end of the vibrator 6 which is protruded from the hollow body 5 to an outside space is not directly influenced by pressures of the powder/particle materials 3. For this reason, the vibrator 6 is completely embedded inside the hollow body 5 so as to be covered with the powder/particle materials 3, and the vibrator 6 can reliably vibrate even in the case where the vibrator 6 is unlikely to vibrate under influence of the pressures of the powder/particle materials. Therefore, according to the damping member 2 in this embodiment, it is possible to realize the damping effect even in the case where the vibration of the structure 1 is small.

The embodiment as shown in FIG. 11 corresponds to the embodiment as shown in FIG. 3 in which the vibrator 6 passes loosely through the inner wall face of the hollow body 5. However, it is also possible to apply them to the vibrator 6 in a shape of a rod or a plate in the other embodiments. Moreover, both ends of the vibrator 6 may be protruded to the outside space of the hollow body 5 so that the vibrator 6 pierces both the side faces (inner wall faces at both sides) of the hollow body 5.

In these embodiments too, it is preferable that the vibrators 6 are so constructed as to sympathetically vibrate in the frequency zone to be damped, because the vibrators 6 can move the powder/particle materials 3 more violently in this manner.

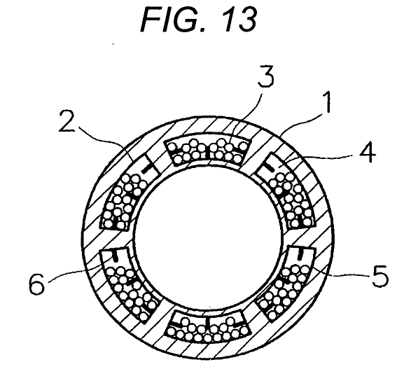

In the embodiments as shown in FIGS. 12 and 13, the structure 1 to be damped is a stator of a motor. In these embodiments, hollow bodies 5 (damping members 2) filled with the powder/particle materials 3 are not mounted to the structure 1, but incorporated in the stator (structure 1). The stator has a cylindrical shape, and a plurality of the hollow bodies 5 in a shape of an arc having a same size and filled with the powder/particle materials 3 are formed at equal intervals in a circumferential direction. Although it is preferable that all of the plurality of the hollow bodies 5 have the same size and are formed at the equal intervals, the hollow bodies 5 need not necessarily have the same size, and need not be necessarily formed at the equal intervals.

In the embodiment as shown in FIG. 12, only one vibrator 6 in a shape of a rod or a plate is provided in each of the hollow bodies 5. In the embodiment as shown in FIG. 13, a plurality of vibrators 6 in a shape of a rod or a plate are provided in each of the hollow bodies 5. In the embodiment as shown in FIG. 13, the plurality of the vibrators 6 are provided so-called radially, and therefore, stabilized damping effect can be realized even in the case where a vibration direction of the stator (structure 1) is varied with rotation of a rotor.

It is to be noted that this invention can be also applied to a case where the structure 1 is a rotor, a gear or the like. Specifically, this can be realized by incorporating the hollow bodies 5 (damping members 2) which are filled with the powder/particle materials 3 in the rotor, the gear or the like, in the same manner as the case where the structure 1 is the stator. Because the rotor or the gear rotates, it is preferable that a plurality of the vibrators 6 in a shape of a rod or a plate are provided radially in the same manner as in the embodiment as shown in FIG. 13.

In the above described embodiments, only the case where the structure 1 vibrates in the vertical direction is shown, because the damping effect against small vibration in the vertical direction is more remarkably deteriorated in the prior art. However, the damping structure according to the invention effectively functions even in the case where the structure 1 vibrates in a horizontal direction or in a diagonal direction or in the case of rotating vibration. Moreover, in the above described embodiments, only the case where the powder/particle materials 3 are filled in a closed space is shown. However, the powder/particle materials 3 need not necessarily be filled in the closed space, unless the powder/particle materials 3 leak out.

Although the embodiments of the invention have been described hereinabove, the invention is not limited to the above described embodiments, but can be carried out by modifying in various ways within a scope described in the claims. This application is based on Japanese Patent Application No. 2009-095081 filed on Apr. 9, 2009, the contents of which are hereby incorporated by reference.

### DESCRIPTION OF THE REFERENCE NUMERALS AND SIGNS

1 Structure
2 Damping member
3 Powder/particle material
4 Space
5 Hollow body
6 Vibrator
7 Spring

1. A damping structure comprising a damping member which is provided on a structure to be damped, wherein the damping member is composed of: a hollow body; a powder/particle material which is filled in the hollow body with partially leaving a space, and moves inside the hollow body when the structure to be damped vibrates; and a vibrator which is mounted to the hollow body, and relatively vibrates with respect to the hollow body to come into contact with the powder/particle material to exert a force when the structure to be damped vibrates.

2. The damping structure according to claim 1, wherein the vibrator vibrates with larger amplitude than the hollow body or in a different phase.

3. The damping structure according to claim 1, wherein the vibrator is mounted to the hollow body so that a vibration direction of the vibrator is different from a vibration direction of the structure.

4. The damping structure according to claim 1, wherein the vibrator is mounted to the hollow body so that a shape or mass distribution of the vibrator is unsymmetrical with respect to an axis which passes a point where the vibrator is mounted to the hollow body and is in parallel with the vibration direction of the structure to be damped.

5. The damping structure according to claim 1, wherein an inner wall face of the hollow body is formed in an inclined state with respect to the vibration direction of the structure to be damped.

6. The damping structure according to claim 1, wherein a plurality of the vibrators are provided in the hollow body, and the plurality of the vibrators are constructed so as to vibrate with different amplitudes, respectively, when the structure to be damped vibrates.

7. The damping structure according to claim 1, wherein the vibrator is provided by passing loosely thorough the hollow body so that at least one end of the vibrator is protruded from the hollow body to an exterior.

8. The damping structure according to claim 2, wherein the vibrator is mounted to the hollow body so that a vibration direction of the vibrator is different from a vibration direction of the structure.
